(19) United States
(12) Patent Application Publication
(10) Pub. No.: US 2011/0181976 A1
(43) Pub. Date: Jul. 28, 2011

(54) POWER-SAVING METHOD AND OPERATING SYSTEM FOR THE SAME

(75) Inventors: Shih-Cheng CHOU, Taipei City (TW); Chia-Ming HUANG, Taipei City (TW)

(73) Assignee: COMPAL ELECTRONICS, INC., Taipei City (TW)

(21) Appl. No.: 12/781,733

(22) Filed: May 17, 2010

(30) Foreign Application Priority Data
Jan. 27, 2010 (TW) 99102309

(51) Int. Cl. G11B 20/10

(52) U.S. Cl. 360/39; G9B/20.009

(57) ABSTRACT

A power-saving method adapted in a hard disk in a computer system having a CPU and a memory module is provided. The power-saving method comprises the following steps. A data-to-be-written is transferred from the memory module through the CPU to the hard disk filter. A determining module is provided to determine whether a data access frequency of the computer system exceeds a threshold value. When the data access frequency exceeds the threshold value, the determining module further determines whether a request-queuing time exceeds an idle-mode activation time. When the request-queuing time exceeds the idle-mode activation time interval, the data-to-be-written is stored in a temporary storage location by the hard disk filter. When a condition of the computer system is satisfied, the data-to-be-written is written to the hard disk to extend the duration of an idle-mode of the hard disk. A power-saving operating system is disclosed herein as well.

### RELATED APPLICATIONS

This application claims priority to Taiwan Application Serial Number 99102309, filed Jan. 27, 2010, which is herein incorporated by reference.

### BACKGROUND

1. Technical Field

The present disclosure relates to a data storage operating system and a method for the same. More particularly, the present disclosure relates to a hard-disk-power-saving operating system and a power-saving method for the same.

2. Description of Related Art

A hard disk is a data storage device with high capacity but low data access speed and is commonly installed in computer systems. The host of the computer system issues a data access request before the data is written into the hard disk so that the hard disk performs the data access according to the data access request. In order to reduce power consumption, a power-saving mechanism is provided to turn off the power of the modules in the hard disk gradually when the hard disk idles over a specific time period. However, even when the hard disk has low usage, the host still performs data access on the hard disk at every fixed time interval. Under such circumstances, the hard disk is not able to enter the idle-mode because of the steady data access described above. Thus, the power-saving mechanism can't be accomplished.

Accordingly, what is needed is a power-saving method and a power-saving operating system to avoid the drawbacks described above to accomplish the power-saving mechanism. The present disclosure addresses such a need.

### SUMMARY

An aspect of the present disclosure is to provide a power-saving method adapted in a hard disk in a computer system comprising a CPU and a memory module connected to the CPU. The power-saving method comprises the following steps. A data-to-be-written is transferred from the memory module through the CPU to the hard disk filter. A determining module is provided to determine whether a data access frequency of the computer system exceeds a threshold value. When the data access frequency exceeds the threshold value, the determining module further determines whether a request-queuing time exceeds an idle-mode activation time. When the request-queuing time exceeds the idle-mode activation time interval, the data-to-be-written is stored in a temporary storage location by the hard disk filter. When a condition of the computer system is satisfied, the data-to-be-written is written to the hard disk to extend the duration of an idle-mode of the hard disk.

Another aspect of the present disclosure is to provide a power-saving operating system adapted in a computer system comprising a CPU and a memory module connected to the CPU. The power-saving operating system comprises a hard disk, a hard disk filter and a detection module. The hard disk is connected to the memory module. The hard disk filter receives a data-to-be-written from the memory module through the CPU. The detection module is connected to the CPU, the memory module, the hard disk filter and the hard disk to detect whether a data access frequency of the computer system exceeds a threshold value and to detect whether a request-queuing time exceeds an idle-mode activation time interval, wherein the detection module drives the hard disk filter according to a comparison result of the request-queuing time and the idle-mode activation time interval such that the data-to-be-written is stored in a temporary storage location until a condition of the computer system is satisfied to make the data-to-be-written written to the hard disk.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a block diagram of a computer system of an embodiment of the present disclosure; and

FIG. 2 is a flow chart of the power-saving method of another embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

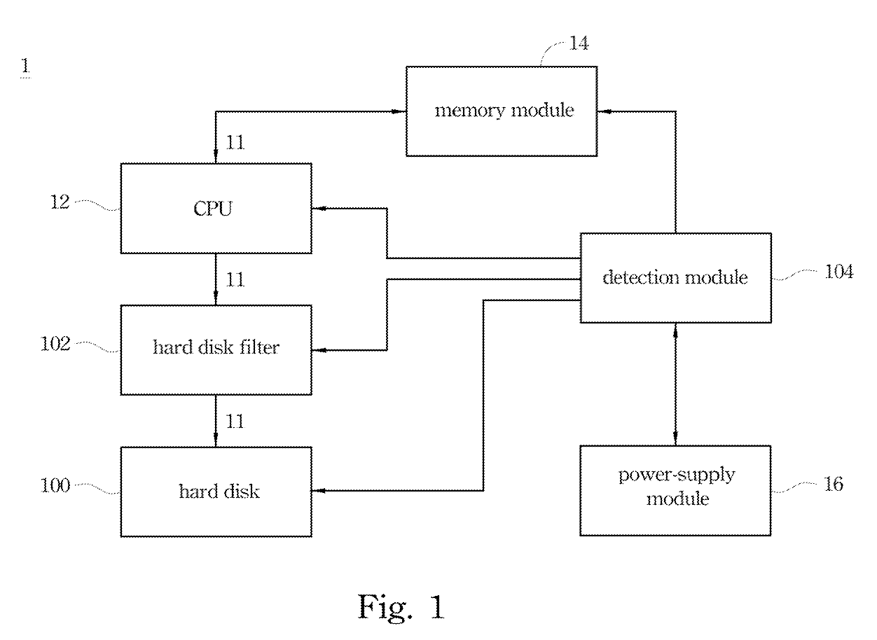

Please refer to FIG. 1. FIG. 1 is a block diagram of a computer system 1 of an embodiment of the present disclosure. The computer system 1 can be a desktop or a laptop. The computer system 1 comprises a power-saving operating system, a CPU 12, a memory module 14 and a power-supply module 16.

The power-saving operating system comprises a hard disk 100, a hard disk filter 102 and a detection module 104. The CPU 12, the memory module 14, the hard disk filter 102 and the detection module 104 are substantially the core of the computer system 1 that is able to perform the processing of the data, whereas the hard disk 100 stores data that is not used instantly due to the characteristics of high capacity and low access speed. The power-supply module 16 supplies the power to the core of the computer system 1.

When the core of the computer system 1 is operating, the CPU 12 performs the calculations and processes on the data and accesses the data in need through the memory module 14. Therefore, the data before processing and the data after processing are both stored temporarily in the memory module 14. In an embodiment, the memory module 14 is a random access memory or a non-volatile memory. Nevertheless, the CPU 12 needs to write data into the hard disk 100 through the memory module 14.

The time interval between two consecutive data accesses performed by the core of the computer system 1 on the hard disk 100 is called request-queuing time. The hard disk 100 is able to enter the idle-mode when there is no data access over a specific period of time to accomplish the power-saving mechanism. The specific period of time for entering the idle-mode, i.e. the idle-mode activation time interval, may take one second. However, even the computer system 1 is under low usage, the computer system 1 still writes data into the hard disk 100 at every fixed time interval. Under such a circumstance, the hard disk 100 is not able to enter the idle-mode or can only enter the idle-mode for a short period of time because of the steady data access described above. Thus, the power-saving mechanism can't be accomplished.

The hard disk filter 102 receives the data-to-be-written 11 from the memory module 14 through the CPU 12. The detection module 104 is connected to power-supply module 16, the CPU 12, the memory module 14, the hard disk filter 102 and the hard disk 100 to detect whether a data access frequency of the computer system 1 exceeds a threshold value and to detect whether a request-queuing time exceeds an idle-mode activation time interval.

Through the connections of the CPU 12, the memory module 14, the hard disk filter 102 and the hard disk 100, the detection module 104 can determine whether the system is busy or whether there is a lot of data accesses performed on the hard disk 100. After the analysis, the detection module 104 can determine whether the data access frequency of the computer system 1 exceeds the threshold value. The detection module 104 for determining whether the system is busy is a conventional technology, such as the detection module in Windows 7. Thus, the type of the detection module 104 doesn't restrict the scope of the present disclosure.

On the other side, whether the request-queuing time exceeds an idle-mode activation time interval can be determined through the duration of the s time interval between two consecutive data accesses performed by the core of the computer system 1 on the hard disk 100.

When the detection module 104 determines that the data access frequency does not exceed the threshold value and the request-queuing time exceeds the idle-mode activation time interval, the hard disk filter 102 makes the data-to-be-written 11 stored in a temporary storage location. In an embodiment, the temporary storage location is in the memory module 14. In other words, the hard disk filter 102 stops writing the data-to-be-written 11 into the hard disk 100 and keeps the data-to-be-written 11 in the memory module 14. In another embodiment, the hard disk filter 102 comprises a data register, whereas the temporary storage location is substantially in the data register (not shown). When the data-to-be-written 11 is stored in the temporary storage location over a predetermined time period, or when the temporary storage location is full of the data-to-be-written 11, the data-to-be-written 11 stored in the temporary storage location are written into the hard disk 100. The duration of the predetermined time period and the size of the temporary storage location can be adjusted according to different conditions.

It's noticed that the hard disk filter 102 described above can be implemented by either hardware or software. Generally speaking, if the temporary storage location is in the memory module 14 itself, the hard disk filter 102 can be implemented by software. On the other hand, if the hard disk filter 102 comprises the temporary storage location, i.e. the data register, the hard disk filter 102 can be implemented by hardware. However, the implementation of the hard disk filter 102 doesn't restrict the scope of the present disclosure.

Before the operation of the hard disk filter 102, the detection module 104 can further detect whether the power of the power-supply module is not enough. When the power is not enough, the data-to-be-written 11 is written into the hard disk 100 directly to avoid data loss due to the insufficient power.

When the detection module 104 determines that the data access frequency does not exceed the threshold value and the request-queuing time does not exceed the idle-mode activation time interval, the hard disk filter 102 makes the data-to-be-written 11 written into the hard disk 100 directly because the hard disk 100 is busy performing data access.

The power-saving operating system is able to keep the data-to-be-written 11 in the temporary storage location instead of writing the data-to-be-written 11 into the hard disk 100 directly when the computer system 1 is not busy. Consequently, the hard disk 100 can enter the idle-mode after the request-queuing time exceeds the idle-mode activation time interval and the duration of the idle-mode can extend as well to accomplish the power-saving mechanism.

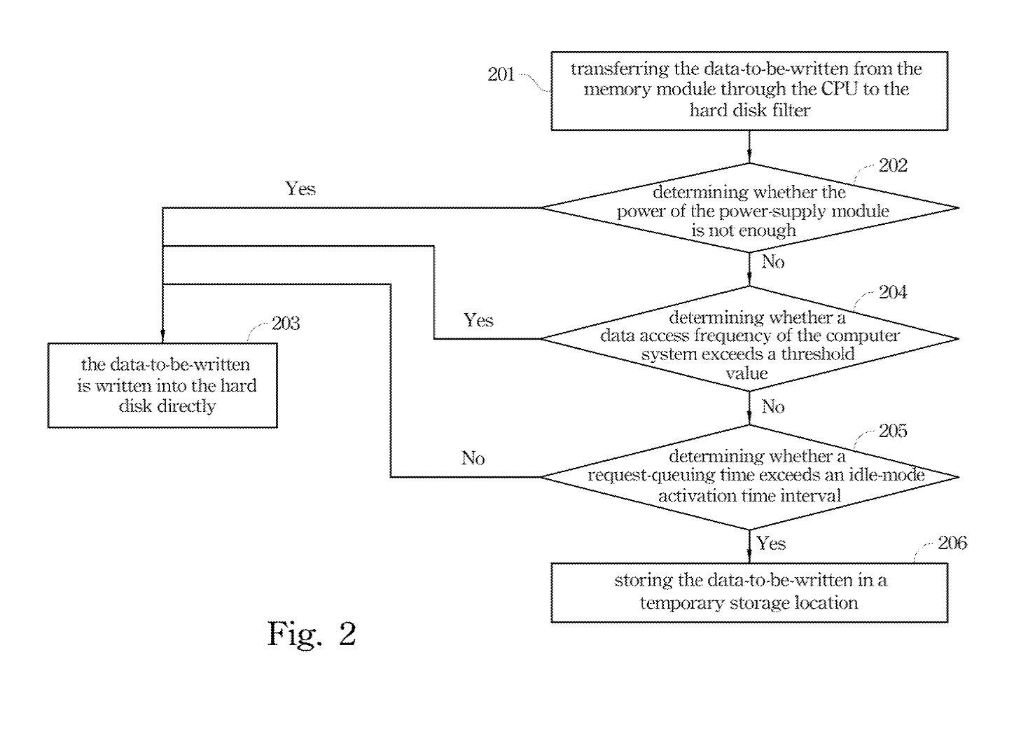

Please refer to FIG. 2. FIG. 2 is a flow chart of the power-saving method of another embodiment of the present disclosure. The power-saving method can be adapted in a computer system 1 depicted in FIG. 1. The power-saving method comprises the following steps. In step 201, a data-to-be-written 11 is transferred from the memory module 14 through the CPU 12 to the hard disk filter. In step 202, a determining module 104 is provided to determine whether the power of the power-supply module 16 is not enough. If there is not enough power, data-to-be-written 11 is written into the hard disk 100 as shown in step 203. When there is enough power, the determining module 104 further determines whether a data access frequency of the computer system 1 exceeds a threshold value as shown in step 204. When the data access frequency exceeds the threshold value, data-to-be-written 11 is written into the hard disk 100 as shown in step 203. When the data access frequency doesn't exceed the threshold, the determining module 104 further determines whether a request-queuing time exceeds an idle-mode activation time of the hard disk as shown in step 205. When the request-queuing time does not exceed the idle-mode activation time interval, data-to-be-written 11 is written into the hard disk 100 as shown in step 203. When the request-queuing time exceeds the idle-mode activation time interval, the data-to-be-written 11 is stored in a temporary storage location by the hard disk filter 102 as shown in step 206. When a condition of the computer system 1 is satisfied, the data-to-be-written 11 is written into the hard disk 100 as shown in step 203 to extend the duration of the idle-mode of the hard disk 100. The condition is satisfied when the data-to-be-written 11 is stored in the temporary storage location over a predetermined time period or when the temporary storage location is full of the data-to-be-written 11. The predetermined time period and the temporary storage described above are both adjustable.

The steps are not recited in the sequence in which the steps are performed. That is, unless the sequence of the steps is expressly indicated, the sequence of the steps is interchangeable, and all or part of the steps may be simultaneously, partially simultaneously, or sequentially performed

The advantage of the present disclosure is to keep the data-to-be-written in the temporary storage location instead of writing the data-to-be-written into the hard disk directly when the computer system is not busy. Consequently, the hard disk can enter the idle-mode after the request-queuing time exceeds the idle-mode activation time interval and the duration of the idle-mode can extend as well to accomplish the power-saving mechanism.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A power-saving method adapted in a hard disk in a computer system comprising a CPU and a memory module connected to the CPU, the power-saving method comprises the steps of:
transferring the data-to-be-written from the memory module through the CPU to the hard disk filter;
providing a determining module to determine whether a data access frequency of the computer system exceeds a threshold value;
wherein when the data access frequency does not exceed the threshold value, the determining module further determines whether a request-queuing time exceeds an idle-mode activation time interval;
when the request-queuing time exceeds the idle-mode activation time interval, the data-to-be-written is stored in a temporary storage location by the hard disk filter; and
when a condition of the computer system is satisfied, the data-to-be-written is written to the hard disk to extend the duration of an idle-mode of the hard disk.

2. The power-saving method of claim 1, wherein the computer system further comprises a power-supply module, before the steps of determining whether the data access frequency of the computer system exceeds the threshold value, the power-saving method further comprises the steps of:
providing the determining module to determine whether the power of the power-supply module is not enough; and
when the power is not enough, the data-to-be-written is written into the hard disk directly; and
when the power is enough, the steps of determining whether the data access frequency of the computer system exceeds the threshold value is performed.

3. The power-saving method of claim 1, when the data access frequency of the computer system exceeds the threshold value, the data-to-be-written is written into the hard disk directly.

4. The power-saving method of claim 1, wherein the temporary storage location is substantially in the memory module.

5. The power-saving method of claim 1, wherein the temporary storage location is substantially in a data register.

6. The power-saving method of claim 1, wherein the condition is satisfied when the data-to-be-written is stored in the temporary storage location over a predetermined time period.

7. The power-saving method of claim 1, wherein the condition is satisfied when the temporary storage location is full of the data-to-be-written.

8. A power-saving operating system adapted in a computer system comprising a CPU and a memory module connected to the CPU, the power-saving operating system comprises:
a hard disk connected to the memory module;
a hard disk filter to receive a data-to-be-written from the memory module through the CPU; and
a detection module connected to the CPU, the memory module, the hard disk filter and the hard disk to detect whether a data access frequency of the computer system exceeds a threshold value and to detect whether a request-queuing time exceeds an idle-mode activation time interval, wherein the detection module drives the hard disk filter according to a comparison result of the request-queuing time and the idle-mode activation time interval such that the data-to-be-written is stored in a temporary storage location until a condition of the computer system is satisfied to make the data-to-be-written written to the hard disk.

9. The power-saving operating system of claim. 8, the computer system further comprises a power-supply module, wherein the detection module is further connected to the power-supply module to detect whether the power of the power-supply module is not enough such that when the power is not enough, the data-to-be-written is written into the hard disk directly.

10. The power-saving operating system of claim 8, when the detection module determines that the data access frequency of the computer system exceeds the threshold value, the hard disk filter makes the data-to-be-written written into the hard disk directly.

11. The power-saving operating system of claim 8, wherein the temporary storage location is substantially in the memory module.

12. The power-saving operating system of claim 8, wherein the temporary storage location is substantially in a data register.

13. The power-saving operating system of claim 8, wherein the condition is satisfied when the data-to-be-written is stored in the temporary storage location over a predetermined time period.

14. The power-saving operating system of claim 8, wherein the condition is satisfied when the temporary storage location is full of the data-to-be-written.
